(19) United States
(12) Patent Application Publication
(10) Pub. No.: US 2005/0221679 A1
(43) Pub. Date: Oct. 6, 2005

(54) Quick connector

(75) Inventor: Akira Takayanagi, Aichi (JP)

Correspondence Address: DARBY & DARBY P.C., P. O. BOX 5257, NEW YORK, NY, 10150-5257, US

(73) Assignee: TOKAI RUBBER INDUSTRIES, LTD., Komaki-shi (JP)

(21) Appl. No.: 11/068,094

(22) Filed: Feb. 28, 2005

(30) Foreign Application Priority Data
Mar. 31, 2004 (JP) 2004-102069

(51) Int. Cl. H01R 24/00

(52) U.S. Cl. 439/676

(57) ABSTRACT

A quick connector includes: a connector housing having at one end side in an axial direction thereof a tube connecting portion and at other end side in the axial direction thereof a substantially cylindrical retainer holding portion; and a retainer fitted into the retainer holding portion, the retainer having a retainer body and a disengagement operating portion, the retainer body being formed so as to be snap engaged with an annular engagement portion provided on an insert end portion of a pipe, the disengagement operating portion extending from the retainer body toward the other end side in the axial direction. The retainer holding portion has an operating portion receiver that projects radially outwardly at a position corresponding to the disengagement operating portion, and the operating portion receiver receives the disengagement operating portion therein.

### BACKGROUND OF THE INVENTION

1. Field of the Invention

This invention relates to a quick connector used to join together pipes in a gasoline fuel system for an automobile, for example.

2. Description of the Related Art

As a connector applied to the connection of a pipe and a resin tube, which is an opposed member of the pipe, in the piping for a gasoline fuel system for an automobile, a quick connector formed so as to be snap engaged with the pipe is used. Such a quick connector can connect the resin tube to the pipe when the quick connector is snap engaged with the pipe and joined thereto by one pressing action while a tube connecting portion at one end side in an axial direction of the quick connector is fit into the resin tube and an insert end portion of the pipe is inserted into an opening at the other end in the axial direction of the quick connector.

For example, as disclosed in U.S. Pat. No. 6,129,393, snap engagement structures for a quick connector include a structure in which a retainer holding portion is provided on the other end side in an axial direction of a connector housing having a tube connecting portion at one end in the axial direction thereof, and a retainer, which is formed so as to be snap engaged with an insert end portion of a pipe, is fit into the retainer holding portion. In this snap engagement structure, a cross-sectionally C-shaped retainer body having at the other end in the axial direction thereof a pair of operating arms integrally formed thereon is used as the retainer. Such a retainer is fitted into the retainer holding portion so that a pair of engagement claws provided on the other end side in the axial direction thereof enter engagement windows formed in the retainer holding portion with operating end portions of the operating arms engaged with the other end of the retainer holding portion. The retainer or retainer body is provided with engagement slits at one end portion thereof. When the insert end portion of the pipe is inserted into the retainer holding portion or into the retainer, an annular engagement projection formed on the insert end portion is engaged with the engagement slits of the retainer, so that the pipe is joined to the quick connector.

The pipe inserted into and joined to the quick connector is drawn with the retainer from the quick connector when the retainer is drawn out from the retainer holding portion after the width of a space between the operating arms is reduced by pressing the two operating arms of the retainer from the outside to cause the engagement claws to come out of the engagement windows.

### SUMMARY OF THE INVENTION

The insert end portion of the pipe inserted into the quick connector passes through the retainer holding portion, and is inserted further to the interior of the connector housing toward the one end side in the axial direction beyond the retainer holding portion. Apart between an insert end side of the insert end portion extending from the retainer holding portion toward the one end side and the connector housing is sealed with a seal member provided in the connector housing. The insert end side of the pipe is relatively supported by an inner surface of the connector housing directly, or via a bush and the like to eliminate a backlash.

However, in a structure in which the insert end side only of the pipe is relatively supported on an inner surface of the connector housing, the occurrence of a backlash between the quick connector and pipe cannot be sufficiently prevented. When two seal members and a bush are provided between the inner surface of the connector housing and the pipe, the pipe is supported stably to a certain extent, but it can not be said that the relative displacement between the quick connector and pipe does not occur. When the relative displacement occurs between the quick connector and pipe, the sealability of the quick connector lowers, and, when the displacement takes place continuously, there is the possibility that the seal members with which a clearance between the pipe and connector housing is sealed wear away. Especially, in a case where one seal member is used, and, in a case where two seal members are used in a slightly spaced manner, backlash is liable to occur.

In order to prevent such inconveniences, it is preferable to employ a structure in which the other end side opposite to the insert end side of the pipe is also supported by the inner surface of the connector housing or the inner surface of the retainer holding portion. However, since operating arms are arranged at the other end side of the interior of the retainer holding portion, the inner surface of the retainer holding portion cannot be utilized effectively for the prevention of the occurrence of a relative backlash of the pipe.

An object of this invention is to provide a quick connector capable of constituting a pipe connecting structure having a high stability.

According to an aspect of the invention, there is provided a quick connector including: a connector housing having at one end side in an axial direction thereof a tube connecting portion and at other end side in the axial direction thereof a cylindrical or substantially cylindrical retainer holding portion; and a retainer fitted into the retainer holding portion, the retainer having a retainer body and a disengagement operating portion, the retainer body being formed so as to be snap engaged with an annular engagement portion provided on an insert end portion of a pipe when the insert end portion of the pipe is inserted into the retainer holding portion, the disengagement operating portion extending or projecting from the retainer body toward the other end side in the axial direction at least up to a position in a vicinity of an other end of the retainer holding portion in the axial direction; wherein the retainer holding portion has an operating portion receiver that projects radially outwardly at a position corresponding to the disengagement operating portion, and the operating portion receiver receives the disengagement operating portion therein. The disengagement operating portion of the retainer is formed so that it is held in the operating portion receiver. When the disengagement operating portion is held in the operating portion receiver, it positioned on the radial outer side or in a stepped-state. Therefore, a circumferentially wide range of an inner surface of the other end portion of the retainer holding portion becomes able to be used for the prevention of the occurrence of a relative backlash of the pipe, so that the stability between the pipe and quick connector can be improved.

As a backlash preventing structure, a structure in which the retainer holding portion has an inner diameter at the other end in the axial direction thereof which is the same or substantially same as an outer diameter of a large diameter portion that is provided on one side, which is opposite to an insert end side of the pipe, of the annular engagement portion; the retainer holding portion houses the large diameter portion in the other end thereof when the insert end portion of the pipe is inserted into the retainer holding portion; and the disengagement operating portion is positioned on a radial outer side of the large diameter portion while being received in the operating portion receiver can be employed. Constituting the backlash preventing structure in this manner can eliminate the necessity of aligning the quick connector with the pipe in the circumferential direction for fit-joining the quick connector and pipe together.

In many cases, the disengagement operating portion of the retainer is formed so that the disengagement operating portion can be deformed radially inwardly. Therefore, it is preferable that a radial clearance for operating the disengagement operating portion is defined between these disengagement operating portion and the large-diameter portion of the pipe to be arranged in the other end side of the retainer holding portion.

Further, when the large-diameter portion is provided as an annular projection formed at the insert end portion of the pipe, the growing in size of a pipe connecting portion can be avoided.

The quick connector according to the present invention prevents during a pipe connecting operation the disengagement operating portion of the retainer from obstructing the formation of a satisfactory backlash preventing structure.

### BRIEF DESCRIPTION OF THE DRAWINGS

FIG. 1 is a perspective view showing a quick connector according to an embodiment of the present invention and a pipe to be joined to this quick connector;

FIG. 2 is a sectional view of the quick connector;

FIG. 3 is a perspective view of a retainer used for the quick connector;

FIG. 4 is a side view of a connector housing of the quick connector;

FIG. 5 is a side view of the quick connector;

FIG. 6 is a sectional view showing a condition of the quick connector with the pipe joined thereto;

FIG. 7 is a side view showing the condition of the quick connector with the pipe joined thereto; and

FIG. 8 is a drawing showing a condition of the quick connector with a checker fixed thereto.

### DETAILED DESCRIPTION OF THE PREFFERED EMBODIMENT

An embodiment of the present invention will now be described with reference to the drawings.

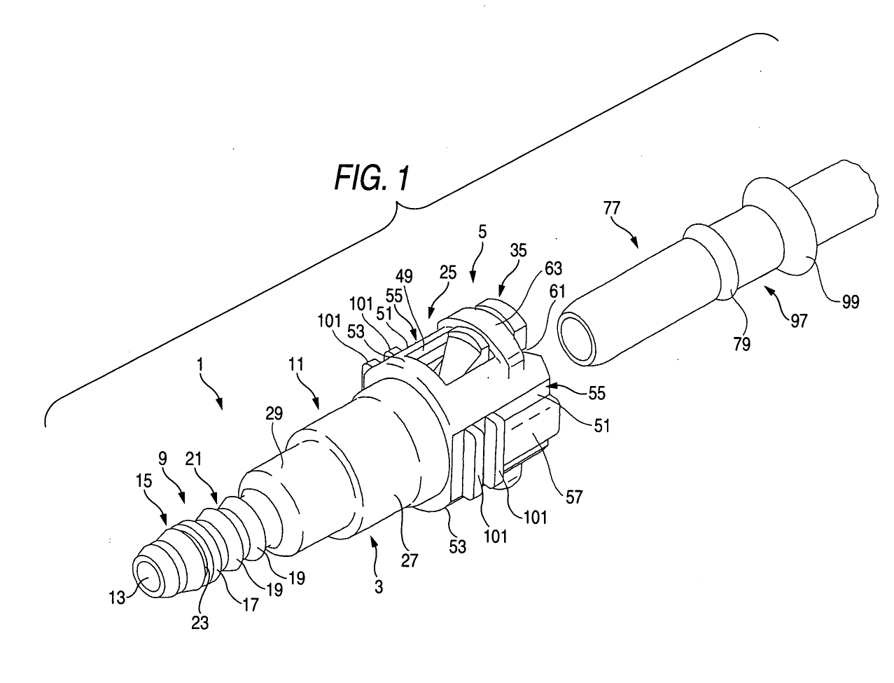

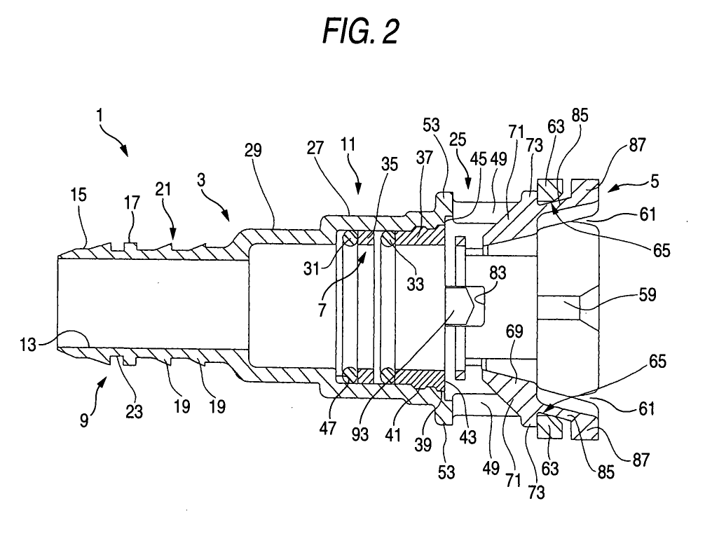

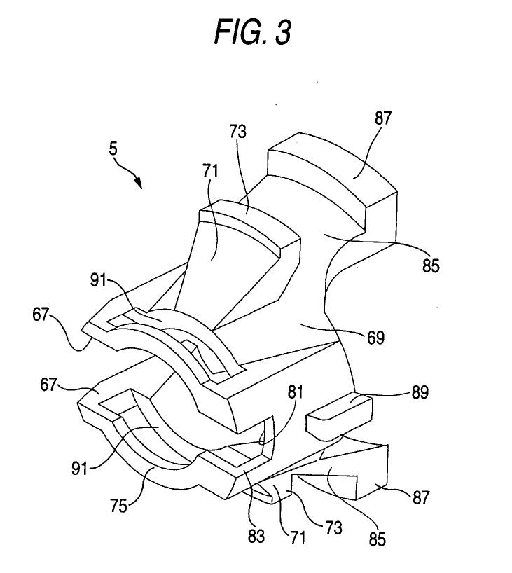

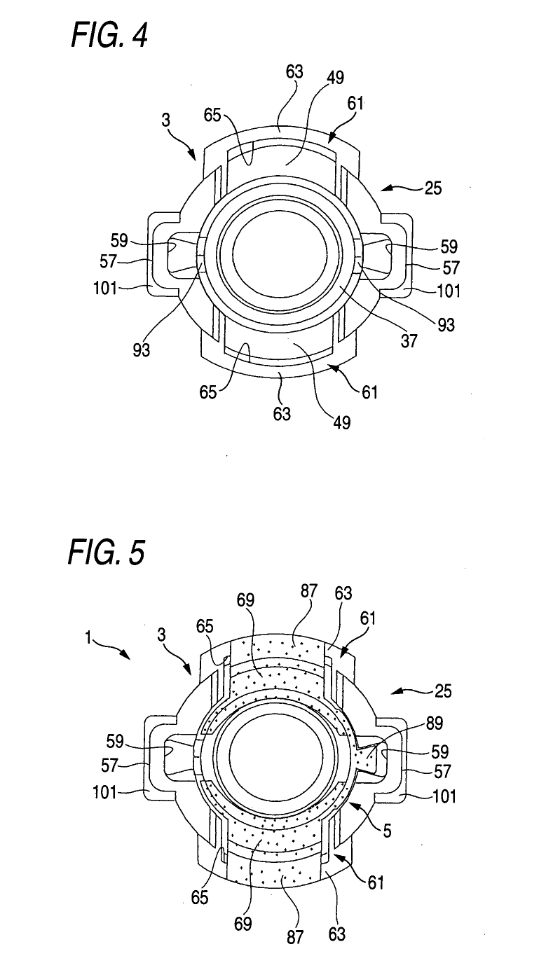

FIG. 1 is a perspective view showing a quick connector according to an embodiment of the present invention and a pipe to be joined to this quick connector, FIG. 2 is a sectional view of the quick connector, FIG. 3 is a perspective view of a retainer used for the quick connector, FIG. 4 is a side view of a connector housing of the quick connector, and FIG. 5 is a side view of the quick connector.

A quick connector 1 is used to join together gasoline fuel pipes for an automobile, and provided with a cylindrical connector housing 3, a substantially annular retainer 5 and a seal member 7. The connector housing 3 is made of glass fiber-reinforced polyamide, and includes a cylindrical resin tube connecting portion 9 atone end side in an axial direction (a tube connecting side) thereof and a substantially cylindrical pipe inserting portion at the other end side in the axial direction (a pipe connecting side) thereof which are made integral with each other. The connector housing further has a through hole 13 extending from a tube connecting side portion to a pipe connecting side portion thereof. The resin tube connecting portion 9 includes a tube connecting side portion 15 an outer circumferential surface of which is enlarged gradually toward the pipe connecting side thereof, and a pipe connecting side portion 21 an outer circumferential surface of which extends as a substantially cylindrical outer surface at a pipe connecting side of the tube connecting side portion 15. An annular, cross-sectionally square slip-off preventing projection 17, and two annular, cross-sectionally right triangular slip-off preventing projections 19, 19 which are enlarged toward the pipe connecting side, are formed on the pipe connecting side portion 21 in an axially spaced manner in a direction from the tube connecting side toward the pipe connecting side. A resin tube is fitted tightly around an outer circumference or an outer circumferential surface of and joined to the resin tube connecting portion 9. An outer circumferential surface 23 (between the tube connecting side portion 15 and annular slip-off preventing projection 17) of a tube connecting side end of the pipe connecting side portion 21 is formed to have a small diameter or as a comparatively deep annular groove. A seal ring (not shown) is fitted around this outer circumferential surface 23 of the tube connecting side end when the resin tube is fitted around the circumferential surface.

A pipe inserting portion 11 of the connector housing 3 integrally includes a large diameter retainer holding portion 25, a seal holding portion 27 the diameter of which is smaller than that of the retainer holding portion 25, and a joint portion 29 at the tube connecting side, the diameter of which is still smaller than that of the seal holding portion 27. In the tube connecting side of an inner circumferential surface of the seal holding portion 27, a first O-ring 31 at the tube connecting side and a second O-ring 33 at the pipe connecting side are fitted side by side via a collar 35, i.e., in an axially spaced manner. In the pipe connecting side of an inner circumferential surface of the seal holding portion 27, a short cylindrical resin bush 37 the inner diameter of which is substantially equal to that of the joint portion 29 is fitted firmly. The resin bush 37 is provided at a pipe connecting side portion and an intermediate portion of an outer circumferential surface thereof with annular projections 39, 41 which extend radially outwardly to a small extent. These projections are integrally formed on the resin bush. A pipe connecting side portion of the inner circumferential surface of the seal holding portion 27 has a cross-sectional shape corresponding to that of the outer circumferential surface of the resin bush 37. The resin bush 37 is fitted firmly in the pipe connecting side portion of the seal holding portion 27 so that a pipe connecting side annular end surface 43 is positioned on the same plane as an annular stepped end surface 45 which is formed at the tube connecting side of the inner side of the retainer holding portion 25. The stepped end surface has a small width and extends radially inwardly. The first O-ring 31 and second O-ring 33 are positioned axially with these rings held between an annular stepped surface 47 formed at the tube connecting side end of the inner side of the seal holding portion 27 and the resin bush 37. The first O-ring 31 is made of, for example, fluoro rubber (FKM) having a high water and dust proofing capability and a high gasoline and ozone resistance, and the second O-ring 33 is made of, for example, fluorosilicone rubber (FVMQ) having a high water and dust proofing capability and a high, low temperature and ozone resistance.

The inner circumferential surface of the substantially cylindrical retainer holding portion 25 is basically or roughly formed to have a cross-sectionally circular shape. The retainer holding portion 25 is provided with engagement windows 49, 49 in an opposed state in radially symmetric portions thereof. The portions of an outer circumferential surface of the retainer holding portion 25 which are between the engagement windows 49, 49 are provided with flat surface regions 51, 51 so that the flat surface regions have radially symmetric positional relation. Therefore, a circumferential wall of the retainer holding portion 25 includes arcuate wall portions provided with the engagement windows 49, 49, and flat wall portions 55, 55 the outer surfaces of which are formed as the flat surface regions 51, 51, and the inner surfaces of which are formed cross-sectionally arcuately. Intermediate portions in a width direction of the respective flat surface regions 51, 51 are provided at the pipe connecting sides thereof with bulging sections 57, 57, which extend axially from the pipe connecting side ends of the flat regions 51 to positions beyond the axial center of the retainer holding portion 25. The retainer holding portion 25 is provided in the regions of the inner circumferential surface thereof which correspond to the bulging portions 57 with cross-sectionally trapezoidal (trapezoidal shape the width of which increases radially outwardly) engagement recesses 59 extending from the pipe connecting side end of the retainer holding portion 25 to the tube connecting side end thereof.

The retainer holding portion 25 or arcuate wall portions 53, 53 are provided with holding recesses 61, 61 in the circumferential regions of the pipe connecting side ends thereof which correspond to the respective engagement windows 49, 49. Engagement wall portions 63, 63 between the respective holding recesses 61, 61 and engagement windows 49, 49 are formed so that these wall portions are positioned so as to project radially outwardly more than the arcuate wall portions 53, 53 which are other than the engagement wall portions 63, 63, or so that the engagement wall portions are positioned on a circle larger than a circle on which the arcuate wall portions 53, 53 other than the engagement wall portions 63, 63 are positioned with a quantity of projection in the outward direction of each of the engagement wall portions 63, 63 substantially equal to the thickness of the arcuate wall portions 53, 53. Therefore, the inner surfaces of the engagement wall portions 63, 63 are positioned on substantially the same circle on which the outer surfaces of the arcuate wall portions 53, 53 are positioned, and the inner surfaces are recessed radially outwardly more than the other inner circumferential surface portions of the retainer holding portion 25 to form operating arm receivers 65, 65 (disengagement portion receivers). In order that the engagement wall portions 63, 63 do not come short of the strength thereof, both of circumferential end portions of the engagement wall portions 63, 63 are made integral with the arcuate wall portions 53, 53 and extend slightly in the circumferential direction.

The retainer holding portion 25 holds therein in a firmly fitted state the retainer 5 made of PA, which is comparatively flexible and formed so that the retainer can be elastically deformed. The retainer 5 has a cross-sectionally C-shaped body 69 provided with a comparatively large deformation clearance between both of circumferential end portions 67, 67. An outer surface of this retainer body 69 is provided on the portions thereof which are in diametrically symmetric positions between which the deformation clearance exists with a pair of engagement claws 71, 71 extending from the tube connecting side to the pipe connecting side of the retainer body. The two engagement claws 71, 71 are formed so as to project gradually in the radially outward direction toward the pipe connecting side of the retainer body, and have at the pipe connecting side end portions thereof engagement claws 73, 73 projecting slightly in the radially outward direction. The inner surface of the body 69 of the retainer 5 except both of the circumferential end portions 67, 67 thereof and the portions opposed to the deformation clearance is formed so as to converge toward the tube connecting side of the body. A tube connecting side end portion 75 of the retainer body 69 except both of the circumferential end portions 67, 67 and the portions opposed to the deformation clearance is formed to have an inner diameter substantially equal to that of a pipe 77 (the portion of the pipe 77 which is other than annular projections thereof), and smaller than that of an annular engagement projection 79. The portion of an inner surface 81 which is opposed to the deformation clearance of the retainer body 69 is formed like a slightly recessed, substantially cylindrical inner surface, and the tube connecting side end portion 75 of a portion opposed to the deformation clearance of the retainer body 69 is provided with a cutout type recess 83.

The engagement claws 71, 71 are provided at the pipe connecting side end thereof or at the radially inner side of the pipe connecting side end surface thereof with a pair of operating arms 85, 85 extending toward the pipe connecting side incliningly in the radially outward direction and made integral with the engagement claws. The respective operating arms 85, 85 are provided at the pipe connecting side end portions thereof with operating end portions 87, 87 projecting in the radially outward direction. An outer surface of the pipe connecting side of the portion of the retainer body 69 which is opposed to the deformation clearance is provided with a cross-sectionally trapezoidal (trapezoidal shape the width of which increases toward the radially outer side) engagement projection 89 narrower than the engagement recess 59 so that the projection extends shortly in the axial direction. The retainer body 69 is provided at a tube connecting side end portion 75 with circumferentially extending engagement slits 91, 91 in an opposed state. The retainer 5 of such construction is forced into and fitted firmly in the retainer holding portion 25 so as to allow the engagement projection 89 to be slidingly moved toward the tube connecting side of the engagement recess 59 and fitted therein, the engagement claws 73, 73 to enter the engagement windows 49, 49 of the retainer holding portion 25, the operating arms 85, 85 to be held in the operating arm receivers 65, 65 on the side of the inner surfaces of the engagement wall portions 63, 63, and the operating end portions 87, 87 to be held in the holding recesses 61, 61. A reference numeral 93 in FIG. 2 denotes a turning preventing projection which is formed on the inner circumferential surface of the retainer holding portion so that the projections are integral therewith, and which is positioned in the cutout type recess 83 of the body 69 of the retainer 5. The same turning preventing projection 93 (refer to FIG. 4) is formed in the diametrically symmetric position as well on the inner circumferential surface of the retainer holding portion 25. Each turning preventing projection 93 is fitted between both of the circumferential end portions 67, 67 of the retainer 5.

The slip-off of the retainer 5 is prevented owing to the engagement of the engagement claws 73, 73 with the pipe connecting side ends (the tube connecting side ends or the tube connecting side end surfaces) of the engagement windows 49, 49. Owing to the engagement of the engagement claws 73, 73 with the circumferential ends of the engagement windows 49, 49 with the turning preventing projection 93 positioned in the cutout type recess 83 of the retainer 5, the retainer is prevented from turning with respect to the connector housing 3 or retainer holding portion 25. Since the engagement projection 89 is fitted in the engagement recess 59 in a circumferentially and radially engaged state, the turning of the retainer is stopped strongly and finely.

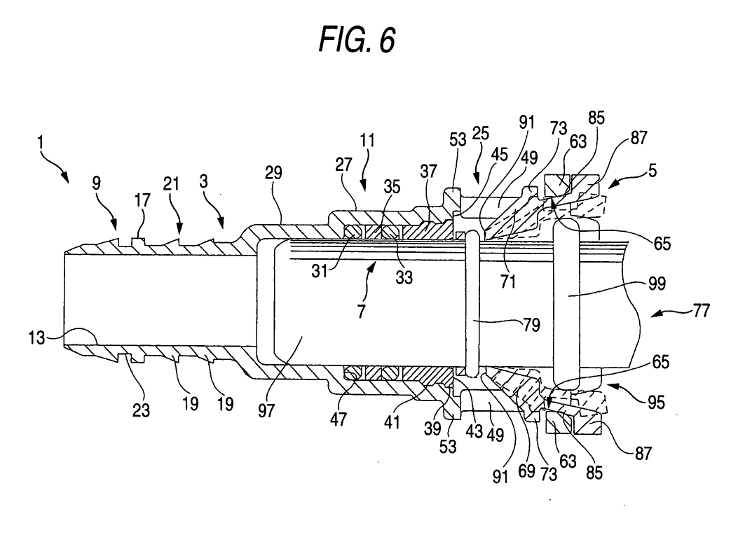

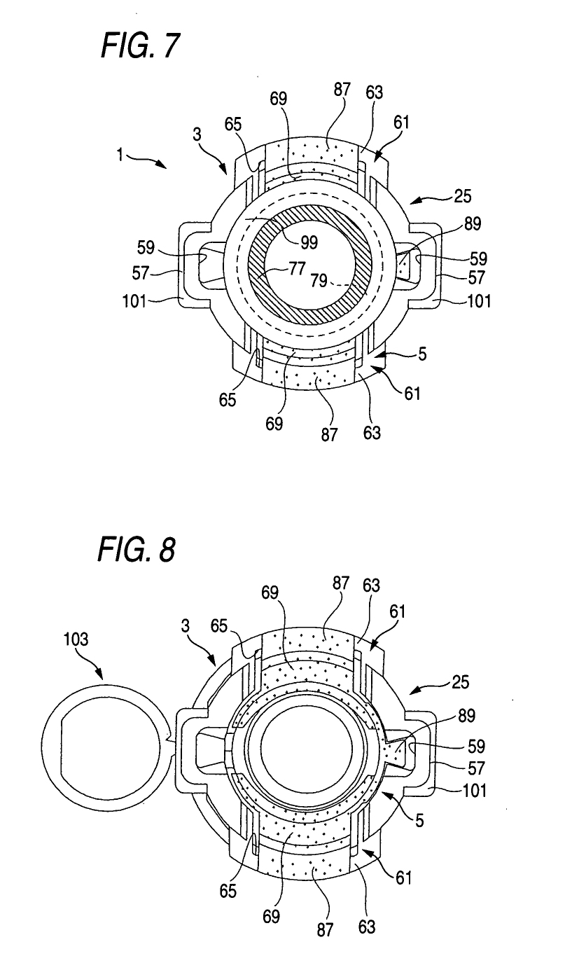

FIG. 6 is a sectional view of the quick connector 1 with the pipe 77 joined thereto, and FIG. 7 a side view of the quick connector 1 with the pipe 77 joined thereto.

The pipe 77 inserted from an opening 95 at the pipe connecting side end of the retainer holding portion 25 into the quick connector 1, and, concretely speaking, the pipe inserted from the side of the operating end portions 87, 87 of the operating arms 85, 85 into the body 69 of the retainer 5 and fitted firmly therein is made of, for example, a metal, and has an annular engagement projection 79 on an outer circumferential surface of the insert end portion 97. This annular engagement projection 79 advances while expanding the body 69 of the retainer 5, and is forcibly fitted in the pipe insert portion 11 of the connector housing 3 until the annular engagement projection is fitted in the engagement slits 91, 91 and snap-engaged therewith. The tube connecting side end of the insert end portion 97 of the pipe 77 passes through the second O-ring 33 and first O-ring 31 and reaches the interior of the joint portion 29. A clearance between the pipe 77 or the insert end portion 97 of the pipe 77 and quick connector 1 is sealed with the first and second O-rings 31, 33. The portion of the pipe which is closer to the tube connecting side thereof than the annular engagement projection 79 of the insert end portion 97 of the pipe 77 is inserted into the resin bush 37 and joint portion 29, the inner diameters of which are substantially equal to the outer diameter of the insert end portion 97 of the pipe 77, in such a manner that a backlash does not occur.

The rear end section of the insert end portion 97 of the pipe 77 is provided thereon with a large-diameter, annular support projection 99 thicker than the annular engagement projection 79 is formed. This annular support projection 99 is provided in the following manner. When the annular engagement projection 79 is snap-engaged with the engagement slits 91 of the retainer 5 with the pipe 77 joined to the quick connector 1, the annular support projection 99 is disposed in the pipe connecting side end portion of the retainer holding portion 25, or in the engagement wall portions 63 in the retainer holding portion 25, or in a position opposed to or substantially opposed to the operating arm receivers 65. The outer diameter of the annular support projection 99 is set substantially equal to the inner diameter of the pipe connecting side end portion of the circumferential wall of the retainer holding portion 25 except the engagement wall portions 63. Accordingly, the annular support projection 99 is fitted closely in the retainer holding portion 25, and relatively supported by the inner surface thereof. Therefore, the pipe 77 is joined at the tube connecting side and at the pipe connecting side end section of the insert end portion 97 thereof to the quick connector 1 with the pipe supported by the quick connector 1 or connector housing 3.

In order to withdraw the pipe 77 from the quick connector 1, the operating end portions 87, 87 of the operating arms 85, 85 held in the holding recesses 61 are pressed from the outside. The operating arm receivers 65 are formed so that the receivers are recessed from the inner circumferential surface of the pipe connecting side end portion of the circumferential wall of the retainer unit 25 excluding the engagement wall portions to a depth corresponding to the thickness of the circumferential wall of the retainer unit 25 but the thickness of the operating arms 85, 85 is about a half of the depth of the operating arm receivers 65. Therefore, when the operating end portions 87, 87 of the operating arms 85, 85 are pressed from the outside, the radial distance between the pipe connecting sides of the operating arms 85, 85, i.e., the radial distance between the engagement claws 73, 73 decreases until the pipe connecting sides of the operating arms 85, 85 are engaged with the annular support projection 99 of the pipe 77, so that the engagement claws 73, 73 come off from the engagement windows 49, 49 (refer to broken lines in FIG. 6). When the retainer 5 in this condition is relatively withdrawn from the connector housing 3, the pipe 77 is withdrawn with the retainer 5 from the quick connector 1 or connector housing 3.

Incidentally, reference numerals 101, 101 in the drawings denote a pair of projections for securing the fixing stability of a checker 103 formed so that the checker 103 can be removed from the connector housing 3 when the pipe 77 is normally joined to the quick connector 1. The checker 103 is held between the projections 101, 101 and fixed to the connector housing 3 (refer to FIG. 8, which is a drawing showing the condition of the checker 103 fixed to the quick connector 1). These two projections 101, 101 are provided on the tube connecting side end portions of the respective flat surface portions.

The quick connector according to the present invention is used for connecting pipes and the like in a fuel system for an automobile, and keeps a high sealability for a long period of time.

1. A quick connector comprising:
a connector housing having atone end side in an axial direction thereof a tube connecting portion and at other end side in the axial direction thereof a cylindrical or substantially cylindrical retainer holding portion; and
a retainer fitted into the retainer holding portion, the retainer having a retainer body and a disengagement operating portion, the retainer body being formed so as to be snap engaged with an annular engagement portion provided on an insert end portion of a pipe when the insert end portion of the pipe is inserted into the retainer holding portion, the disengagement operating portion extending or projecting from the retainer body toward the other end side in the axial direction at least up to a position in a vicinity of an other end of the retainer holding portion in the axial direction;
wherein the retainer holding portion has an operating portion receiver that projects radially outwardly at a position corresponding to the disengagement operating portion, and the operating portion receiver receives the disengagement operating portion therein.

2. The quick connector according to claim 1, wherein the retainer holding portion has an inner diameter at the other end in the axial direction thereof which is the same or substantially same as an outer diameter of a large diameter portion that is provided on one side, which is opposite to an insert end side of the pipe, of the annular engagement portion;
the retainer holding portion houses the large diameter portion in the other end thereof when the insert end portion of the pipe is inserted into the retainer holding portion; and
the disengagement operating portion is positioned on a radial outer side of the large diameter portion while being received in the operating portion receiver.

3. The quick connector according to claim 2, wherein a radial clearance for operating the disengagement operating portion is defined between the disengagement operating portion and the large diameter portion.

4. The quick connector according to claim 1, wherein the retainer holding portion is capable of housing the large diameter portion that is an annular projection formed on the insert end portion of the pipe.
